(19) United States
(12) Patent Application Publication
(10) Pub. No.: US 2008/0319733 A1
(43) Pub. Date: Dec. 25, 2008

(54) SYSTEM AND METHOD TO DYNAMICALLY MANIPULATE AND DISAMBIGUATE CONFUSABLE SPEECH INPUT USING A TABLE

(75) Inventors: Gregory PULZ, Cranbury, NJ (US); Steven DAVIS, Madelia, MN (US); Rahul Deshpande, Monmouth Junction, NJ (US)

Correspondence Address: AT&T CORP., ROOM 2A207, ONE AT&T WAY, BEDMINSTER, NJ, 07921, US

(73) Assignee: AT&T Corp., New York, NY (US)

(21) Appl. No.: 11/765,796

(22) Filed: Jun. 20, 2007

(51) Int. Cl. G06F 17/20

(52) U.S. Cl. 704/1

(57) ABSTRACT

Disclosed are systems, methods, and computer-readable media for disambiguating confusable speech using a table. The method embodiment provides assigning an identifier to each of at least one portion of received speech, querying a table to determine whether at least one entry is associated with the identifier, and if multiple entries are associated in the table with the identifier, then disambiguating between the multiple entries by generating a prompt to the user. Additional features include associating table entries that are not acoustically similar as confusable, presenting the items in the prompt in a sorted order, and dynamically modifying entries in the table.

### BACKGROUND OF THE INVENTION

1. Field of the Invention

The present invention relates in general to automated speech recognition and, in particular, to a system and method to dynamically manipulate and disambiguate confusable speech input through the use of a table.

2. Introduction

Within the field of automated speech recognition (ASR), ASR grammars, also known as language models, describe and constrain user input to a specific set of valid utterances. For example a simple grammar might describe a set of words or phrases which are valid input to a given system. A more complex grammar could include additional language elements and indicate various options and alternatives.

Many telephony based interactive voice response systems JVRs) elicit caller input via speech and attempt to act on that speech based on the use of ASR grammars. After receiving a result from the ASR system, an IVR system typically uses hard-coded program logic to determine its next course of action. Other technologies that utilize ASR grammars are computers that respond and execute user commands or word processors that take dictation.

One interesting case can occur when the ASR system is unable to make a precise determination of the speaker's intent, either because their initial speech was ambiguous, or because there are several valid options in the grammar that may sound similar. If a grammar contains several similar-sounding items, it may be desirable to further clarify (disambiguate) the speaker's intent. For example, if a speaker says “three,” the ASR recognition might return “three”, “tree”, or “free” and the system may need to verify the speaker's intent. Again, the application may be hard-coded. For instance, anytime a caller says “three”, “ctree”, or “free”, an IVR system could return with a hard-coded menu telling the caller to press one for “three”, two for “tree”, or three for “free.” Such hard-coded menus do not allow the ease and flexibility required to optimize interaction with such callers. In some instances, the menu items are presented in an N-best order, with the most likely match being presented first. However, returning menu items in an N-best order is not always the most desirable order to present items to the user. Therefore, there is a need to improve speech recognition manipulation and disambiguation.

### SUMMARY OF THE INVENTION

Additional features and advantages of the invention will be set forth in the description which follows, and in part will be obvious from the description, or may be learned by practice of the invention. The features and advantages of the invention may be realized and obtained by means of the instruments and combinations particularly pointed out in the appended claims. These and other features of the present invention will become more fully apparent from the following description and appended claims, or may be learned by the practice of the invention as set forth herein.

The invention includes a network, a system, a method, and a computer-readable medium associated with dynamically manipulating and disambiguating speech input using a table. An exemplary method embodiment of the invention comprises assigning an identifier to each of at least one portion of received speech, querying a table to determine whether at least one entry is associated with the identifier, and if multiple entries are associated in the table with the identifier, then disambiguating between the multiple entries by generating a prompt to the user. The assignment of the identifier may be accomplished in the ASR grammar. This method allows the table to be easily and dynamically modified to revise a dialog prompting rather than regenerating the ASR grammar.

### BRIEF DESCRIPTION OF THE DRAWINGS

In order to describe the manner in which the above-recited and other advantages and features of the invention can be obtained, a more particular description of the invention briefly described above will be rendered by reference to specific embodiments thereof which are illustrated in the appended drawings. Understanding that these drawings depict only typical embodiments of the invention and are not therefore to be considered to be limiting of its scope, the invention will be described and explained with additional specificity and detail through the use of the accompanying drawings in which:

FIG. 1 illustrates a basic system or computing device embodiment of the invention;

FIG. 2 illustrates an example Interactive Voice Response System according to the present invention;

FIG. 3 illustrates two examples of simple ASR grammars;

FIG. 4 illustrates an example of the association between the grammar, the identifiers, the table, and the table entries; and,

FIG. 5 illustrates a method embodiment of the invention.

### DETAILED DESCRIPTION OF THE INVENTION

Various embodiments of the invention are discussed in detail below. While specific implementations are discussed, it should be understood that this is done for illustration purposes only. A person skilled in the relevant art will recognize that other components and configurations may he used without parting from the spirit and scope of the invention.

The present invention relates to an improved method, system, and computer readable media for dynamically manipulating and disambiguating confusable speech input using a table. A computer system may process some or all of the steps recited in the claims. Those of ordinary skill in the art will understand whether the steps can occur on a single computing device, such as a personal computer having a Pentium central processing unit, or whether some or all of the steps occur on various computer devices distributed in a network. The computer device or devices will function according to software instructions provided in accordance with the principles of the invention. As will become clear in the description below, the physical location of where various steps in the methods occur is irrelevant to the substance of the invention disclosed herein. Accordingly, as used herein, the term “the system” will refer to any computer device or devices that are programmed to function and process the steps of the method.

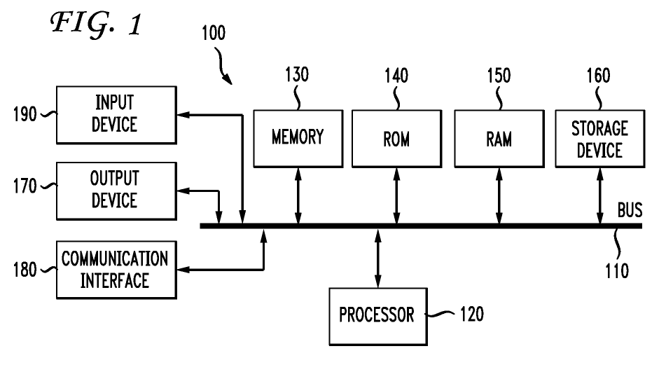

With reference to FIG. 1, an exemplar system for implementing the invention includes a general-purpose computing device 1100, including a processing unit (CPU) 120 and a system bus 1110 that couples various system components including the system memory such as read only memory (ROM) 140 and random access memory (RAM) 150 to the processing unit 120. Other system memory 130 may be available for use as well. It can be appreciated that the invention may operate on a computing device with more than one CPU 120 or on a group or cluster of computing devices networked together to provide greater processing capabilty. The system bus 1110 may be any of several types of bus structures including a memory bus or memory controller, a peripheral bus, and a local bus using any of a variety of bus architectures. A basic input/output (BIOS), containing the basic routine that helps to transfer information between elements within the computing device 100, such as during start-up, is typically stored in ROM 140. The computing device 100 further includes storage means such as a hard disk drive 160, a magnetic disk drive, an optical disk drive, tape drive or the like. The storage device 160 is connected to the system bus 110 by a drive interface. The drives and the associated computer readable media provide nonvolatile storage of computer readable instructions, data structures, program modules and other data for the computing device 100. The basic components are known to those of skill in the art and appropriate variations are contemplated depending on the type of device, such as whether the device is a small, handheld computing device, a desktop computer, or a computer server.

Although the exemplary environment described herein employs the hard disk, it should be appreciated by those skilled in the art that other types of computer readable media which can store data that are accessible by a computer, such as magnetic cassettes, flash memory cards, digital versatile disks, cartridges, random access memories (RAMs) 130, read only memory (ROM), a cable or wireless signal containing a bit stream and the like, may also be used in the exemplary operating environment.

To enable user interaction with the computing device 100, an input device 160 represents any number of input mechanisms, such as a microphone for speech, a touch-sensitive screen for gesture or graphical input, keyboard, mouse, motion input, speech and so forth. The input may be used by the presenter to indicate the beginning of a speech search query. The output device 170 can also be one or more of a number of output means. In some instances, multimodal systems enable a user to provide multiple types of input to communicate with the computing device 100. The communications interface 180 generally governs and manages the user input and system output. There is no restriction on the invention operating on any particular hardware arrangement and therefore the basic features here may easily be substituted for improved hardware or firmware arrangements as they are developed.

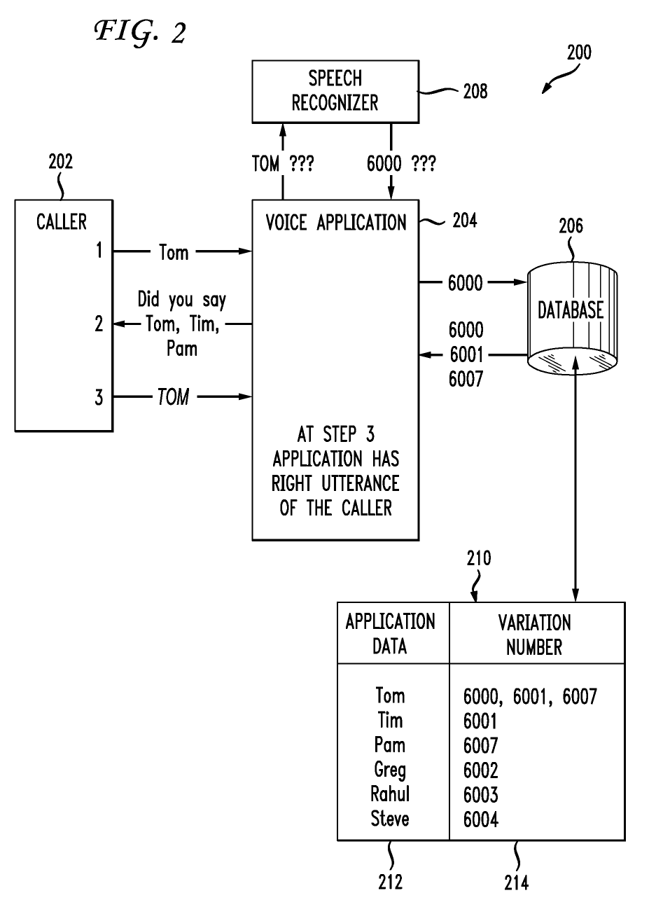

FIG. 2 shows an example IVR system 200. The IVR system receives a speech input from a caller 202. It sends the input to a speech recognizer 208 which returns an identifier (ID) preferably from an ASR grammar. The ID can be used to map the returned ASR response to other data in a table in database 206. The voice application 204 and the speech recognizer 208 utilize the ASR functionality along with a specified grammar in order to capture the speech input and produce the corresponding ID. The database 206 contains entries 210 corresponding to the valid identifiers provided by the speech recognizer. The table entries 212 are defined in the table as confusable depending upon levels set within the table 214. If more than one entry is found in the table for a given identifier, then both items are returned, and the application 204 creates and presents a dynamic prompt to the caller 202 in order to disambiguate the caller's intent.

For example, if the caller 202 says, “Tom,” the voice application 204 captures and sends the signal to a speech recognizer 208. The speech recognizer returns an ID 212 corresponding to “Tom,” which might be the number 6,000, for example. The ID is then mapped to the database 206. The database determines what items and combinations can be associated or confused with the particular phrase, “Tom” 210. For instance, “Tim” might have a variation number of 6001 and “Pam” might have a variation number of 6007 214. The database could determine that only “Tim” is confusable with “Tom” or both “Tim” and “Pam” are confusable with “Tom” depending on how it is defined. In the latter case, the database returns the IDs for “Tom,” “Tim,” and “Pam.” A prompt created by the voice application prompts the caller to clarify whether they meant “Tim,” “Tom,” or “Pam.” The caller would confirm that he said “Tom” and the voice application 204 would be assured that it had the right utterance in that exchange. In a case where the database returns only one item, the application could continue without creating a dynamic prompt to the speaker because there would not be a need to disambiguate.

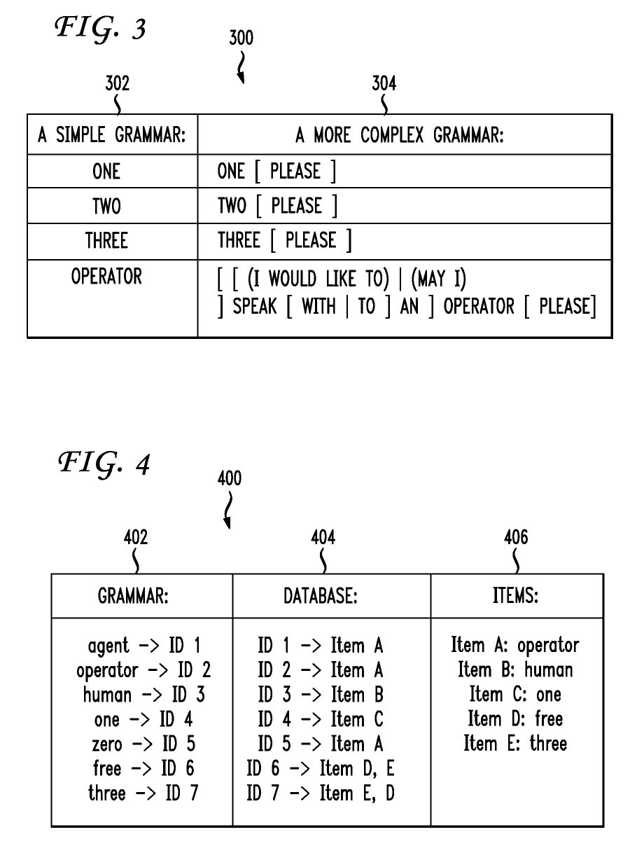

One aspect of the invention is that an ASR grammar assigns an identifier to each of at least one portion of received speech. FIG. 3 shows different examples of an ASR grammar 300. The first example is a simple grammar with a set of words as valid inputs to the system 302. The second example adds additional language elements and indicates various options or alternatives 304. For example, if a speaker says either “one”, or “one please”, the ASR would recognize both phrases as valid inputs to the system. While these simple examples of grammar are provided, they are for illustration and should not be used to limit the scope of the invention. Those of skill in the art will recognize that ASR grammars of varying complexity could be employed. For each valid utterance, the ASR grammar assigns an identifier. This can be a number, a symbol, a character, text, or any other means to identify the location of in the table associated with the utterance. If speech contains more than one valid utterance, then an identifier can be assigned to each of the portions of received speech that constitute a valid utterance.

The identifier that is assigned to each portion of the received speech or to each utterance may or may not be unique to that portion of the received utterance. In one embodiment of the invention, the ASR grammar is designed to return a unique identifier for each valid utterance. The ASR grammar preferably performs no categorization of grammar items. FIG. 4 is an example of how the grammar, the identifiers, the database, and the database entries relate 400. The database is structured so there is a single entry for each ASR grammar item 402. The single entry provides a mapping of the ASR result to the desired action/menu 404. If the caller speaks an option with only a single item associated (ID 1, 2, 3, 4, or 5), the application does not necessarily create any menu. If more than one item is associated with a grammar ID, then a dynamic menu will be generated (ID 6 or 7) based on the list of items stored in the database 406. For example if the ASR recognized “three” (ID 7 [symbol] Item E,D), the dynamic menu might prompt, “For ‘three’ menu tickets, press ‘1’. For ‘free’ movie tickets, press ‘2’.”

Another aspect of the invention is that the entries in the table can be dynamically modified. The table structure allows the definition of similarity between various items within the grammar, along with frequency of use of each item. As an example, associations between table entries and their corresponding identifiers might be defined depending on who the speaker is. For one speaker, “John” and “Jan” might be defined as confusable while for another speaker, “John” and “Joan” would be defined as confusable. Furthermore, entries in the table can change dynamically. For example, if the caller indicates that he speaks Spanish, the entry John” confusable with “Tom” could be replaced by “Juan” confusable with “Jose.” These entries and their corresponding identifiers can be defined at run-time both automatically, such as by the application code, or manually. For example, table entries may be modified automatically based on outside information, current news or other events external dialogue system or may be automatically modified through retrieved information or parameters associated with the user such as culture, gender, language, or location. An example would be to create a user profile for both Fred and Tom. If Fred had invested in both Sysco® and Cisco® while Tom had invested in Cisco® and Cisco®, the system could dynamically change the levels in the table to associate Sysco® and Cisco® as confusable after determining that Fred was talking. If the system determined that Tom was speaking, then it could associate Cisco® and Crisco® as confusable. Table entries can be modified manually as well. An example would be a user providing input that they prefer a German speaking agent causing the table entries to be modified accordingly, or a company changing the names of the agents available by having somebody type them into the table.

One aspect of the invention is that table entries may be associated as confusable, whether there are actual acoustic similarities between the entries or not. This allows for conceptually similar ideas to be defined as confusable. For example, if the caller says, “I want to hear the news”, based upon levels set within the table, such as using variation numbers, the table could return “Current events”, “Sports”, ‘Entertainment”, etc., and a dynamic prompt would be produced to the caller accordingly. However, this should not be construed to limit the invention as being able to associate only conceptually similar ideas as confusable. Acoustic similarities, the frequency with which the valid utterance is spoken, speaker information such as location, gender, etc., and other factors can be used in order to define table associations.

In another example, assume a person is interacting with a spoken dialogue system. The person says, “I would like to speak to an agent.” The grammar or some other process assigns an ID to this utterance such as a number, 500. The number 500 when referenced in the table includes the opportunity to speak with several agents such as John and Mary. The possible disambiguation response could be to present the user the option to speak to either John or Mary. This may be helpful if there is an indication that the user would rather speak to a male rather than female agent. In another example, if it is determined that the user has a certain culture, such as Spanish or German, then the entries in the table associated with the number 500 can be modified for Spanish or German names and the routing of the call can be to agents that speak those languages. Accordingly, an aspect of the invention may be to gather information about the user such as languages, culture, gender, or any other kind of information that may impinge upon the appropriate table entries associated with an ID. Then the system may dynamically alter the entries in a table at the beginning or throughout a dialogue with the user. Accordingly, this dynamic aspect of the invention enables for much greater flexibility in modifying the interactions in a spoken dialogue system with a user that is consistent with and much more preferable to a particular user's desires.

The entries returned as confusable do not need to be in any particular order when they are presented in the dynamic prompt to the user. Various sorting algorithms may be used to determine what order would best maximize the user experience. For example, if the caller requested to hear the news, the dynamic prompt could present various news stories returned by the table in chronological order or based on user-rating. Another example includes sorting entries based on gender. If a poll showed that 80% of people preferred talking to a female agent, then entries corresponding to female associates might be presented first in the dynamic prompt. Items could also be presented based on an N-best order, through a speaker profile such as location and language, or in other ways designed to optimize user performance. The prompts based on table entries may also be used for purposes other than disambiguation. For example, the entries may provide fillers for information to be given to the user. Therefore, current stock quotes, sports stories, news, or any other type of information may be provided in the table.

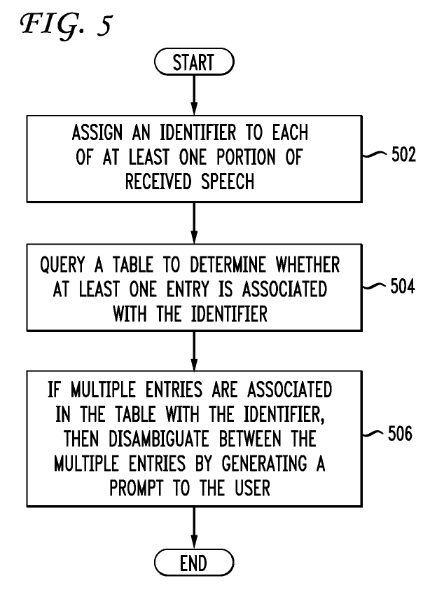

FIG. 5 illustrates a method embodiment of the system 500. The method comprises assigning an identifier to at least one portion of received speech 502. The identifier wilt typically be produced by an ASR grammar or some other process and will be unique for each valid utterance. If the speaker says a phrase or sentence that contains multiple valid grammar inputs, then the system has the option of assigning identifiers to each of the valid grammar inputs. Next, the method comprises querying a table to determine whether at least one entry is associated with the identifier 504. The method also comprises disambiguating between the multiple entries by generating a prompt to the user if multiple entries are associated in the table with the identifier 506.

Embodiments within the scope of the present invention may also include computer-readable media for carrying or having computer-executable instructions or data structures stored thereon. Such computer-readable media can be any available media that can be accessed by a general purpose or special purpose computer. By way of example, and not limitation, such computer-readable media can comprise RAM, ROM, EEPROM, CD-ROM or other optical disk storage, magnetic disk storage or other magnetic storage devices, or any other medium which can be used to carry or store desired program code means in the form of computer-executable instructions or data structures. When information is transferred or provided over a network or another communications connection (either hardwired, wireless, or combination thereof to a computer, the computer properly views the connection as a computer-readable medium. Thus, any such connection is properly termed a computer-readable medium. Combinations of the above should also be included within the scope of the computer-readable media.

Computer-executable instructions include, for example, instructions and data which cause a general purpose computer, special purpose computer, or special purpose processing device to perform a certain function or group of functions. Computer-executable instructions also include program modules that are executed by computers in stand-alone or network environments. Generally, program modules include routines, programs, objects, components, and data structures, etc. that perform particular tasks or implement particular abstract data types. Computer-executable instructions, associated data structures, and program modules represent examples of the program code means for executing steps of the methods disclosed herein. The particular sequence of such executable instructions or associated data structures represents examples of corresponding acts for implementing the functions described in such steps.

Those of skill in the art will appreciate that other embodiments of the invention may be practiced in network computing environments with many types of computer system configurations, including personal computers, hand-held devices, multi-processor systems, microprocessor-based or programmable consumer electronics, network PCs, minicomputers, mainframe computers, and the like. Embodiments may also be practiced in distributed computing environments where tasks are performed by local and remote processing devices that are linked (either by hardwired links, wireless links, or by a combination thereof) through a communications network. In a distributed computing environment, program modules may be located in both local and remote memory storage devices.

Although the above description may contain specific details, they should not be construed as limiting the claims in any way. Other configurations of the described embodiments of the invention are part of the scope of this invention. Accordingly, the appended claims and their legal equivalents should only define the invention, rather than any specific examples given. The examples provided above relate primarily to interactive voice response systems. However, these examples should not be used to limit the scope of the invention. Those of skill in the art will recognize that the invention can be used in different applications that utilize automated speech recognition. Examples would include word processors that take dictation, machines that execute instructions upon a user's spoken command, and multimodal interactions where prompts may be provided onscreen rather than vocally.

I claim:

1. A method of disambiguating potentially confusable speech, the method comprising:
assigning an identifier to each of at least one portion of received speech;
querying a table to determine whether at least one entry is associated with the identifier; and,
if multiple entries are associated in the table with the identifier, then disambiguating between the multiple entries by generating a prompt to the user.

2. The method of claim 1, wherein for at least one identifier, there are multiple entries in the table that are associated as confusable for which the multiple entries do not have acoustic similarities.

3. The method of claim 1, wherein the prompt presents each of the multiple entries in a sorted order.

4. The method of claim 1, wherein an ASR grammar assigns the identifier to each of the at least one portion of speech.

5. The method of claim 4, wherein each possible output from the ASR grammar has a unique identifier.

6. The method of claim 1, wherein the method is practiced in an interactive voice response system.

7. The method of claim 1, wherein the identifier is unique for each portion of the received speech.

8. The method of claim 1, wherein table entries are modified dynamically.

9. The method of claim 8, wherein the table entries are modified either automatically or manually.

10. The method of claim 8, wherein characteristics of the received speech or characteristics of the speaker are used to dynamically modify table entries.

11. The method of claim 10, wherein at least one of a speaker's language, location, or gender is used to dynamically modify table entries.

12. A system for disambiguating potentially confusable speech, the system comprising:
a module configured to assign an identifier to each of at least one portion of received speech;
a module configured to query a table to determine whether at least one entry is associated with the identifier; and,
a module configured to if multiple entries are associated in the table with the identifier, then disambiguating between the multiple entries by generating a prompt to the user.

13. The system of claim 12, wherein for at least one identifier, there are multiple entries in the table that are associated as confusable for which the multiple entries do not have acoustic similarities.

14. The system of claim 12, wherein the prompt presents each of the multiple entries in a sorted order.

15. The method of claim 12, wherein table entries are modified dynamically.

16. A computer readable medium storing a computer program having instructions for controlling a computing device to disambiguate potentially confusable speech, the instructions comprising:
assigning an identifier to each of at least one portion of received speech;
querying a table to determine whether at least one entry is associated with the identifier; and,
if multiple entries are associated in the table with the identifier, then disambiguating between the multiple entries by generating a prompt to the user.

17. The computer-readable medium of claim 16, wherein for at least one identifier, there are multiple entries in the table that are associated as confusable for which the multiple entries do not have acoustic similarities.

18. The computer-readable medium of claim 16, wherein the prompt presents each of the multiple entries either in a sorted order.

19. The computer-readable medium of claim 16, wherein table entries are modified dynamically.
